(19) United States
(12) Patent Application Publication
(10) Pub. No.: US 2024/0352223 A1
(43) Pub. Date: Oct. 24, 2024

(54) BIODEGRADABLE PLASTIC BALL

(71) Applicant: ATOM AIRSOFT OY, Hämeenlinna (FI)

(72) Inventor: Sakari VYYRYLÄINEN, Tampere (FI)

(73) Assignee: ATOM AIRSOFT OY, Hämeenlinna (FI)

(21) Appl. No.: 18/685,571

(22) PCT Filed: Nov. 18, 2021
(86) PCT No.: PCT/FI2021/050785

§ 371 Date: Feb. 22, 2024

(30) Foreign Application Priority Data
Sep. 16, 2021 (FI) 20215977

(51) Int. Cl. C08K 3/22; C08K 3/04; C08K 3/08; F16C 33/32; F42B 6/10

(52) U.S. Cl. CPC C08K 3/22; C08K 3/042; C08K 3/08; F16C 33/32; F42B 6/10; C08K 2003/2213; C08K 2201/009; C08K 2201/018

(57) ABSTRACT

The invention relates to a ball, comprising a biodegradable polymer and one or more additives, such as an electrostatic charge eliminating additive, a density increasing additive, a strength/hardness modifier and/or the like added to the polymer mass during the compounding step. The ball is manufactured by a process generally applicable to the manufacture of polymers, such as injection molding, into a substantially spherical shape and grinding and/or polishing it to its final shape by means of double-sided lapping, barrel tumbling and/or the like. The biodegradable polymer used in the ball is polybutylene succinate (PBS).

The invention relates to a ball as set forth in the independent claim directed thereto.

Plastic, essentially a mixture of a polymer and additives, is presently used to produce a wide range of objects in large quantities thanks to their easy moldability, efficient manufacturing and technical properties.

Bioplastics are plastics that are partly or entirely made of renewable natural materials, or that decompose under certain conditions. Bioplastics can be further divided into bio-based and biodegradable plastics. Bio-based plastics are produced from renewable materials such as cellulose, lignin, chitin, wool or starch. However, biobased plastics are not necessarily biodegradable, and non-biodegradable plastics can also be produced from these materials. Biodegradable plastics are those that, depending on the material, decompose in high temperature industrial composting system or lower temperature home composting system into water and carbon dioxide. Biodegradable plastics can be produced from bio-based materials, but also from fossil raw materials.

Plastic balls made of both biodegradable and non-biodegradable plastic are currently used as ammunition in airsoft guns. The projectiles are spherical plastic balls of varying weights, typically 5.9-6.1 mm in diameter and 0.12-0.48 g in weight. The most common type of plastic used in ammunition is non-biodegradable acrylonitrile butadiene styrene (ABS).

However, for outdoor games, balls made of ABS polymer are quite often forbidden, as it is impractical to collect the balls from the ground. ABS polymer does not biodegrade, causing plastic waste accumulation in the playing area and damage to the environment. For this reason, biodegradable plastic balls are used for outdoor airsoft games. Currently, biodegradable balls are made from materials such as polylactide (PLA, (C₃H₄O₂)ₙ), which is typically made from renewable, bio-based materials such as starches. However, in practice PLA has turned out to be decomposing slowly in soil or home composting system and thus requires industrial composting where the temperature is raised above 60° C. to enhance degradation.

In some cases, biodegradable balls are made by arranging an organic core inside a polymer shell in order to promote faster biodegradation. However, the manufacturing process for such balls is more complex and expensive compared to injection molded plastic balls, and their shelf life is reduced due to the organic core.

Plastic balls can be manufactured by conventional methods suitable for the production of plastic parts, such as injection molding. In injection molding, the balls can be molded directly into a sphere or hemisphere shape in a mold, wherein the latter case the two hemispherical pieces are joined together after molding. After molding, the balls must be grinded and polished to their final shape. The purpose of grinding and polishing is to remove flashes and other molding defects from the surface of the ball, to finish the surface to the required surface roughness and to ensure the sphericity of the ball.

Balls made of plastic are also used as balls for slotted sealed ball bearings or valves where cleanliness and moisture resistance are required, e.g., in the food industry, cosmetics or pharmaceutical packaging or in underwater bearings or similar applications where conventional metal bearings corrode and/or pose a risk of contamination.

The objective of a ball according to the present invention, made from a biodegradable PBS polymer and additives, is to provide a decisive remedy for the foregoing problems and to thereby elevate substantially the existing prior art. In order to attain this objective, the ball according to the invention is principally characterized by what is presented in the characterizing part of an independent claim directed thereto. The invention enables a ball made of biodegradable material, which is self-degradable under natural conditions, to be used for a number of purposes.

Polybutylene succinate (PBS, (C₈H₁₂O₄)ₙ) is a biodegradable polymer classified as a thermoplastic, which can be produced from bio-based materials, but also from fossil raw materials. Traditionally, PBS polymer is produced from chemicals derived from petrochemical products of crude oil, such as amber acid and 1,4-butanediol as the main feedstocks. However, both of these feedstocks can also be produced from a bio-based materials. Bio-based PBS is made from renewable raw materials such as sugar cane, cassava or maize and its manufacturing is patented by Mitsubishi Chemical Corporation and marketed under the brand name BioPBS™. PBS polymer degrades at a significantly lower temperature compared to PLA plastic, breaking down into biomass, water and carbon dioxide at temperatures as low as 30° C., making it suitable for composting in home composting systems or open-air landfills. It can be disposed of with other biowaste.

PBS has similar properties to polypropylene (PP) or polyethylene terephthalate (PET). These properties allow PBS to be processed for applications in the plastics industries and allow the usage of existing manufacturing processes, such as injection molding, and various grinding and polishing processes, to be used in the manufacturing of products made from it.

The polymeric material of the ball according to the invention is thus a polybutylene succinate, to which various additives are added during the production process to modify and improve the physical properties, thus obtaining a biodegradable plastic ball with properties suitable for the particular application, such as for example for outdoor airsoft games as a gun ammunition.

The dependent claims directed to a ball of the invention present other preferred embodiments therefor.

In the subsequent specification, the invention will be described in detail.

The invention relates to a ball comprising a biodegradable polymer and one or more additives, such as an antistatic agent, density agent, a increasing a strength/hardness modifier and/or the like added to the polymer mass during the compounding step. The ball is manufactured by a process suitable for production of polymers, such as injection molding, into a substantially spherical shape and then grinded and/or polished to its final shape by double-sided lapping, barrel tumbling and/or the like. The biodegradable polymer used in the ball is polybutylene succinate (PBS).

In particular, fillers can be used to modify the density of a plastic composition, wherein the fillers are typically powdered metal oxides; such as alumina, magnesia or the like; pure metal powders such as sodium; alloy metal powders; salts of metals, semimetals and alkali metals; such as silicon dioxide and/or the like; minerals, mineral and ionic compounds; such as barium sulphate, calcium hydroxide or lime, cerium oxide, magnesium hydroxide, calcium carbonate, dolomite, kaolin, aluminum hydroxide, wollastonite and/or kieselguhr; glass, carbon, aramid or natural fibers or filaments and/or the like.

In a preferred embodiment of the invention, the density of the abovementioned fillers is at least 1.27 g/cm³ to increase the overall density of the plastic composition. In a preferred advantageous embodiment of the invention, the amount of biodegradable polybutylene succinate, acting as a binder polymer in the composition, is between 22 and 60 wt %, more preferably between 34 and 60 wt %, to achieve the required hardness/strength properties.

The balls can be manufactured by any method suitable for the production of plastics, such as injection molding, wherein a granulate made from plastic mass is fed into the injection screw of a molding machine, melted and injected into a mold. After cooling, the mold is opened and 30 the molded plastic part is removed from the mold.

When casting small-sized balls, the mold contains several identical pieces at a time. The individual balls are separated either by using a molding method in which the balls are removed from the molding runners when the mold opens, or alternatively by cutting the balls out of the supporting structure formed by the molding runners after molding. After molding, the balls are ground, which can be achieved by any method suitable for grinding spherical parts, such as for example double-sided lapping, barrel tumbling and/or similar, whereby the molding defects and possible flashes are removed and the sphericity of the ball is improved. After grinding, the balls are polished to the final surface finish, e.g., with the abovementioned processes and with a suitable polishing agent, and then further screened for non-standard balls.

In a preferred embodiment of the invention, the ball to be manufactured comprises at least one antistatic agent, i.e., a static charge eliminator. In a still further preferred embodiment, the additive used herein is first of all a permanent static charge eliminator, such as an electrically conductive polymer electrolyte formed by a polymer and salts and/or an electrically conductive carbon, graphene and/or the like, and/or a hygroscopic humectant absorbing moisture from the ambient air, such as a moisture absorbing salt, to provide surface conductivity.

In a still further preferred embodiment of the invention, the balls are coated with a static charge elimination agent, such as a hygroscopic humectant that absorbs moisture from the ambient air, to provide surface conductivity.

In a still further preferred embodiment of the invention, the balls are intended to be used in particular as ammunition for an airsoft gun, or alternatively, for example, in a bearing application as a ball for a slotted sealed ball bearing or the like, wherein the diameter of the ball is, for example, between 0.25 and 51 mm in diameter in accordance with the standard dimensions of a steel bearing ball. The balls according to the invention can also be used, for example, in valves with significantly larger diameters.

It is obvious that the invention is not limited to the embodiments presented or described above, but can be modified within the basic context of the invention, depending on the circumstances, by using the most suitable mixture of PBS polymer, other polymers and/or additives for the manufacture of the ball. The properties of the PBS polymer can be modified, for example, by nanocomposites such as fibers and metal or metal oxide nanoparticles, resulting in increased strength and/or biodegradability of the polymer. Furthermore, it is possible to add materials to the ball, e.g., a material that causes the ball to glow in the dark after an exposure in a gun's lighter tracer unit, allowing the ball's trajectory to be assessed in low light conditions when used as an airsoft ammunition. It is also possible to dye the balls for better detectability, or coat them with a dye to detect a hit. The size, density and weight of the ball may vary depending on the intended use, making it possible to use biodegradable balls as shotgun pellets, different air weapons or in games, for example, where the size of the ball used may vary significantly. Depending on the application, the ball can be further coated with metal to modify the surface properties or to improve durability, e.g., in valve applications.

1. A ball, comprising a biodegradable polymer and one or more additives, such as an electrostatic charge eliminating additive, a density increasing additive, a strength/hardness modifying additive and/or the like added to the polymer mass during compounding stage, wherein the ball is manufactured by a process suitable for the manufacture of polymers, such as injection molding, into a substantially spherical shape and grinding and/or polishing the ball to its final shape by means of double-sided lapping, barrel tumbling and/or the like, wherein the biodegradable polymer used in the ball is polybutylene succinate (PBS) and the density increasing additive is at least one of a cerium oxide and a pure metal powder.

2. The ball according to claim 1, wherein the amount of polybutene succinate (PBS) in the ball is between 22 and 60% by weight.

3. (canceled)

4. The ball according to claim 1, wherein the strength/hardness modifying additive is metal powder or mineral, glass, carbon, aramid or natural fiber or filament.

5. The ball according to claim 1, wherein the polymer used for its manufacture is doped with a permanent electrostatic charge eliminating additive, such as an electrically conductive polymer electrolyte of a polymer and salts and/or an electrically conductive carbon, nanocarbon, graphene.

6. The ball according to claim 1, wherein the polymer used for its manufacture is doped with an electrostatic charge eliminating additive, such as a hygroscopic humectant that absorbs moisture from the ambient air to provide surface conductivity.

7. The ball of according to claim 1, wherein the ball is coated with an electrostatic charge eliminating additive, such as hygroscopic humectant that absorbs moisture from ambient air to provide surface conductivity.

8. The ball according to claim 1, wherein the ball is for use as an airsoft ammunition.

9. The ball according to claim 8, wherein the diameter of the ball is between 2 and 10 mm.

10. The ball according to claim 1, wherein the ball is for use in bearing applications.

11. The ball according to claim 1, wherein the ball is for use in valves.
